(19) United States
(12) Patent Application Publication
(10) Pub. No.: US 2020/0101654 A1
(43) Pub. Date: Apr. 2, 2020

(54) Wire Bank Cutter Assembly

(71) Applicant: JMP Industries, Inc., Cleveland, OH (US)

(72) Inventor: James M. Pinchot, Cleveland, OH (US)

(21) Appl. No.: 16/580,239

(22) Filed: Sep. 24, 2019

Related U.S. Application Data
(60) Provisional application No. 62/740,111, filed on Oct. 2, 2018.

(51) Int. Cl. B29C 48/00

(52) U.S. Cl. CPC B29C 48/0022

(57) ABSTRACT

A wire cutting assembly used to cut extrusions formed from an extrusion system.

The present invention claims priority on U.S. Provisional Application Ser. No. 62/740,111 filed Oct. 2, 2018, which is incorporated herein by reference.

The present invention is directed to a cutting assembly, and more particularly to a cutting assembly used to cut extrusions formed from an extrusion system, and still more particularly to a wire cutting assembly used to cut extrusions formed from an extrusion system.

### BACKGROUND OF THE INVENTION

Many types of products are extruded from dies and cut to certain lengths after being extruded through the die. Such products include, but are not limited to, catalysts, human and animal foods, fertilizer, medication, various types of plastic and/or other polymer products, fiber reinforced products, metal, glass, etc. For some types of products (e.g., medication, fertilizer, catalysts, etc.), the cut extruded product should be as uniform as possible. The rate at which a certain product is extruded through a particular die can at least partially depend on a variety of factors such as the wearing of the die components, the wearing of the auger, the density of the product, whether the auger is starved of feed material, plugging of one or more dies inserts, etc. As a result of one or more of these variable factors and/or other factors, the rate at which a particular product extrudes through one or more dies can periodically vary. This varying of the rate of product extrusion commonly results in the cut extruded product being of a non-uniform length, thereby resulting in a significant percent of the product being discarded.

Products formed for the medical and catalyst industry are highly sensitive to product uniformity. The uniform size of a catalyst is used to control certain types of chemical reactions. In some types of chemical reactions, a large tolerance as to size variations is acceptable for the catalyst in these chemical reactions. Due to these large acceptable tolerances as to catalyst size, the catalyst could be extruded and cut using conventional technology, resulting in about 65-85% of the cut catalyst being acceptable for use. However, when the tolerances for the size of the catalyst are small when the catalyst is used in other types of chemical reactions, the amount of wasted cut catalyst significantly increases, thereby increasing product costs. In the medical industry, the tolerance for the size of the medical pill is very low so as to ensure that essentially the same dosage of medicine is present in each pill. As such, most drug manufacturers use a pill manufacturing process. Pill machines are also used to form some types of catalysts that require a low tolerance to the size of the catalyst. Although the pill manufacturing process produces a large percentage of medication and catalyst having a desired size, the pill manufacturing process is very expensive as compared with most extrusion processes, and also has extremely slow through-puts, thereby resulting in low output over time and significantly increased manufacturing costs. Such high costs are cost prohibitive for many types of products.

One type of cutting device that is very successful in overcoming the past cutting problems is described in U.S. Pat. Nos. 7,530,806; 7,674,102; 8,186,991; 8,491,294; and 9,138,934, all of which are incorporated herein by reference. Although the cutting device in these patents is effective in cutting many types of extruded materials, softer types of extrusions, extrusions requiring very low tolerances, and/or tubular-shaped extrusions that are used to form ring-shaped catalyst sometimes may not effectively be cut by the cutting device in these patents which results in significant deformation of the cut material.

In view of the current state of art, there is a need for a cutting device that can be used to cut an extruded product in a uniform manner.

### SUMMARY OF THE INVENTION

The present invention relates to extrusion hardware, particularly to a cutting device that can be used to cut an extruded material from an extruder system, and more particularly to a wire cutting assembly that can be used to cut extrusions formed from an extrusion system.

In one non-limiting aspect of the present invention, there is provided a cutting assembly that is configured to cut one or more types of materials that have been extruded from an extruder system. The improved cutting assembly is configured to improve the product quality of cut extruded material by cutting the extruded material within low tolerances to a certain specified length. The improved cutting assembly of the present invention is configured to cut an extruded product from an extruder system that more closely matches the desired length of the product, thereby eliminating the need for forming the product by more expensive processes that have lower through-puts (e.g., pill making machines, etc.). Consequently, products that have historically been formed by pill manufacturing processes (e.g., medication, certain types of catalysts, etc.) can be extruded and cut to a desired length by use of the improved cutting assembly of the present invention. In addition, the improved cutting assembly of the present invention can be used to cut products that are extruded through an extruder system and thereby significantly reduce the amount of waste of such extruded product that historically has to be discarded since the extruded product did not meet the size tolerance parameters of the extruded product. As such, the improved cutting assembly can be connected directly to an extruder to cut extruded product as it exits the extruder, or be positioned in-line with the extruder so as to cut continuously cut extruded product formed by the extruder.

In another and/or alternative non-limiting aspect of the present invention, the improved cutting assembly incorporates several technologies that are used to produce a higher quality cut product. Each one of these technologies individually can result in increased product quality. In addition, the combination of one or more of these technologies can be used to further increase the percentage of produced product having a desired cut length.

In another and/or alternative non-limiting aspect of the present invention, the cutting assembly of the present invention includes an improved control arrangement which can vary the cutting speed to better account for the rate at which a material is extruded from the extruder system. The control arrangement can utilize one or more detections arrangements to detect the rate at which an extruded product is and/or will extrude from the extruder, and thereby control the cutting speed of the cutting assembly. Such detection arrangements include, but are not limited to: 1) detecting a pressure of the material prior to entering one or more openings in the extruder plate and/or extruder/die insert, and/or as the material enters and/or passes through one or more openings in the extruder plate and/or extruder/die insert; 2) using electronic movement/control sensors (e.g., laser sensor, optical sensor [e.g., standard camera, video camera, etc.]), sound sensor, vibration sensor, light sensor, radio frequency sensor, sound wave sensor, electromagnetic wave sensor for non-visible electromagnetic waves [X-rays, infrared light, ultraviolet light, gamma waves, etc.] etc., to detect and/or measure the speed of movement of the material extruded from the extruder; 3) using a weight sensor to measure the weight of material extruded over time to calculate the amount and/or rate at which an extruded material is extruded from the extruder; 4) using a flow rate meter; and/or 5) a mechanical sensor (e.g., rotating wheel, etc.) that is caused to move by the moving extruded material. This monitored information can be used to provide data on the quality of the material being cut, the percentage of the material being cut that is within an acceptable length, and/or to control the speed of cutting to better obtain a desired cut length of the material. As can be appreciated, the detection of the length of the cut material can be monitored at the location of the cutting assembly and/or at some period after the material has been cut (e.g., when the cut material is being conveyed to a drying location, etc.).

In one non-limiting aspect of this embodiment, the pressure of the material prior to and/or as the material is inserted through one or more extruder plate and/or die/extruder insert openings is detected in one or more openings and/or regions about the one or more openings of the extruder plate and/or die/extruder insert so as to at least partially control the speed of cutting of the improved cutting assembly. Such pressure detection can be used to determine whether the material is accelerating, decelerating, or maintaining a constant velocity through the extruder plate and/or extruder/die insert.

In another and/or alternative non-limiting aspect of this embodiment, the temperature of the material prior to and/or as the material is inserted through one or more openings in the extruder plate and/or die/extruder insert is detected in one or more of the openings and/or regions about the one or more openings of the extruder plate and/or die/extruder insert so as to at least partially control the speed of cutting by the cutting assembly.

In still another and/or alternative non-limiting aspect of this embodiment, the velocity of the material prior to and/or as the material is inserted through one or more die openings in the extruder plate and/or die/extruder insert is detected in one or more of the openings and/or regions about the one or more openings of the extruder plate and/or die/extruder insert so as to at least partially control the speed of the cutting by the cutting assembly.

In yet another and/or alternative non-limiting aspect of this embodiment, the average cut product length of the extruded and cut material is actually detected and/or calculated so as to at least partially control the speed of cutting by the cutting assembly.

In another non-limiting embodiment, one or more electronic movement sensors (e.g., laser, camera, vibration sensor, sound sensor, etc.) are used to detect the movement of the material moving into the extruder plate and/or extruder/die insert, moving through the extruder plate and/or extruder/die insert, moving out of the extruder plate and/or extruder/die insert, and/or moving from the extruder plate and/or extruder/die insert after passing through the extruder plate and/or extruder/die insert. The location of the one or more electronic movement sensors is non-limiting.

In still yet another and/or alternative non-limiting aspect of this embodiment, the improved cutting assembly can include one or more adjustable parameters to adjust the length of the extruded material being cut so as to obtain a desired length of the cut material, calibrate one or more detected parameters (e.g., pressure, actual or calculated rate of extrusion, etc.) so that the speed control for the cutting assembly is properly adjusted based upon one or more detected parameters, and/or adjust the delay so as to delay the adjustment of the speed of the cutting by the cutting assembly to account for the time period in which the material travels into and through an extruder plate and/or die/extruder insert, etc.

During the operation of the extruder, if it is determined that the speed of the material (e.g., via pressure reading, via electronic movement sensors, via weight detection, via flow meters, etc.) passing through one or more openings in the extruder plate and/or extruder/die insert has changed and/or is going to change, the speed of the cutter of the cutting assembly can be accordingly adjusted (i.e., decrease or increase) to account for the change in speed at which the material is exiting the extruder plate and/or extruder/die insert. Furthermore, if it is determined that the speed of the material passing through one or more openings in the extruder plate and/or extruder/die insert has remained constant and/or is going to remain constant, the speed of the cutting assembly can be maintained at the same speed. As a result, the control of the cutting speed used to cut the material that has been extruded through one or more openings in the extruder plate and/or extruder/die insert can be controlled so as to maintain a desired cut length of the cut extruded material. The rate of increase or decrease of the cutting speed can be linear or nonlinear. The change in cutting speed can be delayed to account for the time that the material enters into the one or more openings of the extruder plate and/or extruder/die insert and passes through the one or more openings in the extruder plate and/or extruder/die insert prior to being cut by the cutting assembly; however, this is not required. In one non-limiting embodiment of the invention, an electronic control system is used to control the rate at which the cutting assembly cuts the material being extruded from one or more extruder plates and/or extruder/die inserts. In one non-limiting aspect of this embodiment, a pulse width modulator control system can used to control the rate at which the cutting assembly cuts the material being extruded from one or more extruder plates and/or extruder/die inserts. As can be appreciated, other or additional control systems can be used to control the speed of the cutting assembly. In one non-limiting design, one or more motors are used to control the speed of the cutters (e.g., wires) of the cutting assembly. In such a configuration, the pulse width control (PWC) system can be used to control the amount of current to one or more electric motors to thereby control the speed of the one or more motors. Standard electric motors can be used (e.g., motors that include a stator coil (DC motors), motors operated by field induction coil (AC motors), etc.). In another non-limiting design, one or more linear drive systems, pneumatic springs and/or struts can be used to cause the cutting assembly to cut the extruded material. In another and/or alternative non-limiting embodiment of the invention, the control of the cutting speed with respect to the detected or determined speed at which the material is passing though one or more openings of the extruder plate and/or extruder/die insert can be used to adjust the cutting speed to account for abnormalities in the feed rate of the material being extruded. For instance, when one or more of the openings for the extruded material are plugged or clogged, thereby typically resulting in a significant increase in pressure on the extruded material through the remaining unclogged openings, the speed at which the cutting assembly cuts the extruded material can be increased to account for the increased speed at which the material is extruded through the remaining unclogged openings. Likewise, when the auger blade is starved of material and/or there is an inconsistent amount of material being fed by the auger blade to the one or more of the openings, a significant increase/decrease in pressure on the extruded material through the openings can be detected, and the speed at which the cutting assembly cuts the extruded material can be adjusted accordingly to account for the change in speed at which the material is extruded through the one or more openings of the extruder plate and/or extruder/die insert.

In another and/or alternative non-limiting aspect of the present invention, the improved control arrangement can be used to set off alarms (i.e., indicate one or more operations of the extruder are not operating within one or more parameters, etc.) and/or shut down one or more components of the extruder system so as to reduce or prevent damage to one or more components of the extruder system; however, this is not required. This alarm can be used to detect and/or notify an operator of clogged die openings, worn components (e.g., worn/damaged auger blade, worn/damaged wiper blade, worn/damaged extruder plate, worn/damaged die/extruder insert, worn/damaged die pins, damaged/malfunctioning pressure sensors, etc.), insufficient feeding of material to be extruded, damage to the cutting assembly, cutting assembly not operating properly, irregular cut shapes of the extruded material, plugged plates and/or dies, improper cutting lengths of the extruded material, etc.

In another and/or alternative non-limiting aspect of the present invention, the improved control arrangement can include a storage system that stores data regarding, but not limited to the a) detected pressures over a period of time, b) detected rates of extrusion of the material from the extruder, c) cutting speed of the cutting assembly, d) change out frequency of extruder components (e.g., wiper blade, auger blade, extruder plate, extruder/die insert, die pins, etc.), e) types of components used to extrude a material (e.g., size and type of extruder, type of extruder plate, type of auger, type of wiper, type of insert, etc.), f) speed of rotation of the auger blade, g) type of feed material, h) rate of material fed to the auger blade, i) change out frequency of the extruder components, j) change out frequency of the cutting assembly components (e.g., wire cutters, etc.), and/or k) detected, calculated and/or measured cut lengths of the cut extruded material. As can be appreciated, other or additional types of information can be recorded by the cutting assembly. This data can be used to facilitate in determining whether one or more components of the extruder and/or cutting assembly were operating properly during an extrusion process. The data can also or alternatively be used to control the operation of the cutting assembly. The data can be tagged to a time and/or date period; however, this is not required. This data can be designed to be accessed at real time and/or in other manners. The collected data can be used to activate one or more alarms to indicate an existing or potential problem with one or more components of the extruder and/or cutting assembly; however, this is not required. The collected data can be used to activate one or more alarms to indicate that a component change out is due for one or more components of the extruder and/or cutting assembly; however, this is not required. The collected data can be used to profile the operation of one or more components of the extruder and/or cutting assembly; however, this is not required.

In another and/or alternative non-limiting aspect of the present invention, the improved cutting assembly can optionally include one or more sensors other than that sensors used to detect the movement of the extrudate, which other sensor can be used to affect the cutting speed of the cutting assembly and/or be used to activate one or more alarms. Such other sensors can include, but are not limited to, temperature sensors, auger feed flow sensors, composition sensors, auger rotation speed indicators, wire cutting speed detectors, die opening plug detectors, product quality detectors, product cut length detectors, etc. These one or more sensors can be located in one or more openings in the extruder plate and/or extruder/die insert, and/or spaced from one or more openings in the extruder plate and/or extruder/die insert. The data from one or more of these sensors can be recorded; however, this is not required. The data can be tagged to a time and/or date period; however, this is not required. The data from one or more of the sensors can also or alternatively be used to control the operation of one or more components of the cutting assembly (e.g., wire cutting speed, etc.) and/or one or more components of the extruder (e.g., auger rotation speed, material feed rate into auger, etc.). The collected data can be also or alternatively be used to activate one or more alarms to indicate that a component change out is due for one or more components of the extruder, and/or the cutting assembly and/or one or more components of the extruder are not working properly; however, this is not required. The collected data can be used to profile the operation of one or more components of the extruder and/or cutting assembly; however, this is not required. In another and/or alternative embodiment of the invention, additional data can be used by the cutting assembly to monitor and/or control one or more components of the extruder and/or cutting assembly. Such data can include, but is not limited to, extruder plate size, extruder plate opening configuration, extruder plate opening size, material of the extruder plate, thickness of the extruder plate, die/extruder insert size, die/extruder insert shape, die/extruder insert thickness, die/extruder insert material, type of insert pins, shape of insert pins, material of insert pins, type of auger blade, material of auger blade, shape of auger blade, size of auger blade, type of feed material, type of wire cutters, size of wire cutters, number of wire cutters, wire cutter material, spacing of wire cutters, type of wiper blade, spacing of wiper blade from extruder plate and/or die/extruder insert, wiper blade material, recommended change-out/maintenance for one or more components of the extruder and/or cutting assembly, recommended operational parameters of one or more components of the extruder and/or cutting assembly, quality of extruded product, time of usage of one or more components of the extruder and/or cutting assembly, etc. As can be appreciated, other or additional data can be collected, stored, processed, monitored and/or otherwise used by the cutting assembly. As can also be appreciated, the data that is collected, stored, processed, etc., by the cutting assembly can be used to optimize the operation of the extruder system to produce a higher quality of extruded material. As can be appreciated, any data that can be collected, stored, processed, monitored, and/or other used by the cutting assembly can be made available to an operator onsite so that the operator can monitor and/or control one or more operations of the extruder and/or cutting assembly. As can further be appreciated, any data that can be collected, stored, processed, monitored, and/or other used by the cutting assembly can also be transmitted (wire and/or wireless transmission) to a remote location (e.g., control and/or monitoring station, etc.) so that an operator can monitor and/or control one or more operations of the extruder and/or cutting assembly at a remote location.

In another and/or alternative non-limiting aspect of the present invention, the improved cutting assembly includes a movable wire bank assembly and a fixed canister assembly. The cutting assembly is configured to cut extruded products into desired lengths. The wire bank assembly includes a frame to which one or more cutting wires are strung. When the wire bank assembly includes two or more wires, the two or more wires are generally positioned in the same plane; however, this is not required. When the wire bank assembly includes three or more wires, the adjacently positioned wires are generally positioned equidistant from one another; however, this is not required. The wire diameter, wire tension, number of wires, and/or wire spacing can be adjusted depending on the particular requirements. The canister assembly includes one or more channels. When the wire bank assembly includes two or more wires, the canister includes two or more cutting slots that are spaced at the same distance as that of the wires in the wire bank assembly are spaced. The canister assembly can be a) directly mounted to the extruder die plate, b) positioned in stream of the extruded strands, or c) used remotely on a bench for batch processing of extruded material. The canister assembly generally includes a channel arrangement that is formed of one or more beds or channels that are used to lay or transport or guide the extruded strands.

In another and/or alternative non-limiting aspect of the present invention, the wire bank assembly can be attached to the canister assembly by means of a hinge or linkage which allows reciprocating action of the one or more wires into and out of the cutting slots. The wire bank assembly can be operated by hand, pneumatic, hydraulic, and/or electric power. As the extrudate is transported to or placed into the canister section, the reciprocating wire bank assembly is configured to cut such extrudate into desired lengths. The cut sections are then removed from the canister (i.e., manually, transported by extrudate flow, etc.). When the un-cut extrudate strand partially or fully fills the canister section, the wire bank assembly is caused to move so the one or more wires in the wire bank assembly cut the extrudate located in the canister section. The reciprocating action of the wire bank assembly can be timed to allow all cut extrudates to exit the canister sections before the next movement of the wire bank assembly; however, this is not required. The wire bank assembly can be configured to cut in one or both directions.

In another and/or alternative non-limiting aspect of the present invention, the improved cutting assembly includes one or more ultrasonic cutters to at least partially cut material that has been extruded through an extruder plate and/or die/extruder insert; however, this is not required. The ultrasonic frequency is at least about 20 Khz, typically about 22-100 Khz, and more typically about 25-75 kHz; however, it can be appreciated that other frequencies can be used.

In another and/or alternative non-limiting aspect of the present invention, the improved cutting assembly can include one or more operational modes. In one non-limiting embodiment of the invention, one mode of the cutting assembly can be a manual mode, wherein the speed of the wire bank assembly is set and maintained at a substantially constant speed throughout an extrusion process until the speed is manually changed. In another and/or alternative non-limiting embodiment of the invention, the cutting assembly can include an automatic mode, wherein the speed cutting by the wire bank assembly is adjusted based upon one or more set and/or detected parameters (e.g., current weather conditions, time of day, time of year, geographic location, type of extruder, extruder configuration, type of feeder for extruder, extruder plate temperature, auger blade temperature, material to be extruded temperature, material to be extruded flow rate, material to be extruded composition, material to be extruded density, time period required for material to move through one or more openings in extruder plate and/or die/extruder insert, time period required for material to move along auger blade at a certain auger blade rotation speed, auger blade rotation speed, wire cutting speed, extruder plate and/or die/extruder insert opening plug detection, product quality detection, extruder plate pressure detection, pressure in one or more openings of extruder plate and/or die/extruder insert, temperature in one or more openings of extruder plate and/or die/extruder insert, time of use for die/extruder inserts, time of use for extruder plate, time of use for die pins, time of use for auger blade, time of use for liner, type of liner, material of liner, shape of liner, extruder plate size, extruder plate opening configuration, extruder plate opening size, material of the extruder plate, thickness of the extruder plate, die/extruder insert size, die/extruder insert shape, die/extruder insert thickness, die/extruder insert material, die/extruder insert hole profile, type of insert pins, shape of insert pins, material of insert pins, type of auger blade, material of auger blade, size/shape of auger blade, type of feed material, type of wire cutter, number of wire cutters, spacing of wire cutters, wire cutter material, wire cutter type, type of wiper blade, spacing of wiper blade from extruder plate and/or die/extruder insert, wiper blade material, calculated and/or detected wear rates and/or information of one or more components of the extruder and/or cutting assembly, detected and/or calculated speed the extrudate is extruding from the extruder, etc.) so as to obtain the desired cut material length and/or product quality of the extruded and cut material. As mentioned above, one or more of these parameters can be recorded by the cutting assembly and/or one or more other components of the extruder, manually and/or automatically imputed into the cutting assembly and/or one or more other components of the extruder, and/or transmitted to and/or received from a remote location.

In another and/or alternative non-limiting aspect of the present invention, the improved cutting assembly can include various features used to deactivate the cutting assembly, especially when one or more dies are being replaced. It is not uncommon that the extruder plate, die/extruder insert, insert pin, auger blade, wiper blade, liner, etc., has to be periodically serviced and/or replaced after a run by the extruder. A run may be as short as a few minutes or as long as several days or months. When one or more components are removed and/or serviced, it is important not to inadvertently activate the cutting assembly during such operation, wherein such operation could result in the damage to the wire cutters. The improved cutting assembly of the present invention can include one or more detectors, switches, etc., which fully or partially deactivates one or more components of the cutting assembly during repair and/or maintenance of the cutting assembly and/or one or more components of the extruder so as to reduce or prevent damage to one or more components of the cutting assembly.

In still yet a further and/or alternative non-limiting embodiment of the invention, the improved cutting assembly can be ergonomically designed so as to facilitate in the operation of the cutting assembly and/or to facilitate in the repair and maintenance of the cutting assembly. In one non-limiting embodiment of the invention, the cutting assembly allows the operator to easily access various connectors, bolts, switches, etc., which are required for periodic operation and/or maintenance of the cutting assembly. As a result of this ergonomic design, the need for special tools is reduced or eliminated and/or the operation and/or maintenance of the cutting assembly is simplified, thereby reducing the time and/or cost of maintenance and repair.

One non-limiting object of the present invention is the provision of a method and process for forming more uniform cut lengths of an extruded product.

Another and/or alternative non-limiting object of the present invention is the provision of a method and process for a cutting assembly that can be used to improve the forming of more uniform cut lengths of an extruded product.

Another and/or alternative non-limiting object of the present invention is the provision of a method and process for a cutting assembly that can vary the speed of cutting based on one or more detected parameters and/or set variables to improve the forming of more uniform cut lengths of an extruded product.

Another and/or alternative non-limiting object of the present invention is the provision of a method and process for a cutting assembly that can be used to cut an extruded material from an extruder system.

Another and/or alternative non-limiting object of the present invention is the provision of a method and process for a cutting assembly that is configured to improve the product quality of cut extruded material by cutting the extruded material within low tolerances to a certain specified length.

Another and/or alternative non-limiting object of the present invention is the provision of a method and process for a cutting assembly that is configured to cut an extruded product from an extruder system that more closely matches the desired length of the product, thereby eliminating the need for forming the product by more expensive processes that have lower through-puts.

Another and/or alternative non-limiting object of the present invention is the provision of a method and process for a cutting assembly that can be used to cut products that are extruded through an extruder system and thereby significantly reduce the amount of waste of such extruded product.

Another and/or alternative non-limiting object of the present invention is the provision of a method and process for a cutting assembly that can be connected directly to an extruder to cut extruded product as it exits the extruder, or be positioned in-line with the extruder so as to cut continuously cut extruded product formed by the extruder.

Another and/or alternative non-limiting object of the present invention is the provision of a method and process for a cutting assembly that includes a control arrangement which can vary the cutting speed to better account for the rate at which a material is extruded from the extruder system.

Another and/or alternative non-limiting object of the present invention is the provision of a method and process for a cutting assembly that includes a control arrangement that can utilize one or more detections arrangements to detect the rate at which an extruded product is and/or will extrude from the extruder, and thereby control the cutting speed of the cutting assembly.

Another and/or alternative non-limiting object of the present invention is the provision of a method and process for a cutting assembly that includes one or more detection arrangements that can include, but are not limited to: 1) detecting a pressure of the material prior to entering one or more openings in the extruder plate and/or extruder/die insert, and/or as the material enters and/or passes through one or more openings in the extruder plate and/or extruder/die insert; 2) using electronic movement/counter sensors (e.g., laser sensor, optical sensor (e.g., standard camera, video camera, etc.), sound sensor, vibration sensor, light sensor, radio frequency sensor, sound wave sensor, electromagnetic wave sensor for non-visible electromagnetic waves [X-rays, infrared light, ultraviolet light, gamma waves, etc.] to detect and/or measure the speed of movement of the material extruded from the extruder; 3) using a weight sensor to measure the weight of material extruded over time to calculate the amount and/or rate at which an extruded material is extruded from the extruder; 4) using a flow rate meter; and/or 5) a mechanical sensor (e.g., rotating wheel, etc.) that is caused to move by the moving extruded material.

Another and/or alternative non-limiting object of the present invention is the provision of a method and process for a cutting assembly that can use and/or collect data that can be used to provide data on the quality of the material being cut, the percentage of the material being cut that is within an acceptable length, and/or to control the speed of cutting to better obtain a desired cut length of the material.

Another and/or alternative non-limiting object of the present invention is the provision of a method and process for a cutting assembly that can monitor and/or detect the length of the cut material at the location of the cutting assembly and/or at some period after the material has been cut.

Another and/or alternative non-limiting object of the present invention is the provision of a method and process for a cutting assembly wherein the pressure of the material prior to and/or as the material is inserted through one or more extruder plate and/or die/extruder insert openings is detected in one or more openings and/or regions about the one or more openings of the extruder plate and/or die/extruder insert so as to at least partially control the speed of cutting of the improved cutting assembly.

Another and/or alternative non-limiting object of the present invention is the provision of a method and process for a cutting assembly wherein the temperature of the material prior to and/or as the material is inserted through one or more openings in the extruder plate and/or die/extruder insert is detected in one or more of the openings and/or regions about the one or more openings of the extruder plate and/or die/extruder insert so as to at least partially control the speed of cutting by the cutting assembly.

Another and/or alternative non-limiting object of the present invention is the provision of a method and process for a cutting assembly wherein the velocity of the material prior to and/or as the material is inserted through one or more die openings in the extruder plate and/or die/extruder insert is detected in one or more of the openings and/or regions about the one or more openings of the extruder plate and/or die/extruder insert so as to at least partially control the speed of the cutting by the cutting assembly.

Another and/or alternative non-limiting object of the present invention is the provision of a method and process for a cutting assembly wherein the average cut product length of the extruded and cut material is actually detected and/or calculated so as to at least partially control the speed of cutting by the cutting assembly.

Another and/or alternative non-limiting object of the present invention is the provision of a method and process for a cutting assembly that includes one or more electronic movement sensors to detect the movement of the material moving into the extruder plate and/or extruder/die insert, moving through the extruder plate and/or extruder/die insert, moving out of the extruder plate and/or extruder/die insert, and/or moving from the extruder plate and/or extruder/die insert after passing through the extruder plate and/or extruder/die insert.

Another and/or alternative non-limiting object of the present invention is the provision of a method and process for a cutting assembly that can include one or more adjustable parameters to adjust the length of the extruded material being cut so as to obtain a desired length of the cut material, calibrate one or more detected parameters so that the speed control for the cutting assembly is properly adjusted based upon one or more detected parameters, and/or adjust the delay so as to delay the adjustment of the speed of the cutting by the cutting assembly to account for the time period in which the material travels into and through an extruder plate and/or die/extruder insert, etc.

Another and/or alternative non-limiting object of the present invention is the provision of a method and process for a cutting assembly that can account for the change in speed at which the material is exiting the extruder plate and/or extruder/die insert.

Another and/or alternative non-limiting object of the present invention is the provision of a method and process for a cutting assembly that can control the cutting speed used to cut the material that has been extruded through one or more openings in the extruder plate and/or extruder/die insert so as to maintain a desired cut length of the cut extruded material.

Another and/or alternative non-limiting object of the present invention is the provision of a method and process for a cutting assembly that includes an electronic control system to control the rate at which the cutting assembly cuts the material being extruded from one or more extruder plates and/or extruder/die inserts.

Another and/or alternative non-limiting object of the present invention is the provision of a method and process for a cutting assembly that includes one or more linear drive systems, pneumatic springs, and/or struts to cause the cutting assembly to cut the extruded material.

Another and/or alternative non-limiting object of the present invention is the provision of a method and process for a cutting assembly that can include one or more alarms (i.e., indicate one or more operations of the extruder are not operating within one or more parameters, etc.) and/or can be configured to shut down one or more components of the extruder system so as to reduce or prevent damage to one or more components of the extruder system.

Another and/or alternative non-limiting object of the present invention is the provision of a method and process for a cutting assembly that includes a storage system that stores data regarding, but not limited to, the a) detected pressures over a period of time, b) detected rates of extrusion of the material from the extruder, c) cutting speed of the cutting assembly, d) change out frequency of extruder components (e.g., wiper blade, auger blade, extruder plate, extruder/die insert, die pins, etc.), e) types of components used to extrude a material (e.g., size and type of extruder, type of extruder plate, type of auger, type of wiper, type of insert, etc.), f) speed of rotation of the auger blade, g) type of feed material, h) rate of material fed to the auger blade, i) change out frequency of the extruder components, j) change out frequency of the cutting assembly components (e.g., wire cutters, etc.), and/or k) detected, calculated and/or measured cut lengths of the cut extruded material, and which data can be used to 1) facilitate in determining whether one or more components of the extruder and/or cutting assembly were operating properly during an extrusion process, 2) control the operation of the cutting assembly, 3) be accessed at real time and/or in other manners, 4) activate one or more alarms to indicate an existing or potential problem with one or more components of the extruder and/or cutting assembly, 5) activate one or more alarms to indicate that a component change out is due for one or more components of the extruder and/or cutting assembly, and/or 6) profile the operation of one or more components of the extruder and/or cutting assembly.

Another and/or alternative non-limiting object of the present invention is the provision of a method and process for a cutting assembly that includes one or more sensors other than sensors used to detect the movement of the extrudate, which other sensor can be used to affect the cutting speed of the cutting assembly and/or be used to activate one or more alarms.

Another and/or alternative non-limiting object of the present invention is the provision of a method and process for a cutting assembly that includes a movable wire bank assembly and a fixed canister assembly.

Another and/or alternative non-limiting object of the present invention is the provision of a method and process for a cutting assembly wherein the cutting assembly is configured to cut extruded products into desired lengths.

Another and/or alternative non-limiting object of the present invention is the provision of a method and process for a cutting assembly wherein the wire bank assembly includes a frame to which one or more cutting wires are strung.

Another and/or alternative non-limiting object of the present invention is the provision of a method and process for a cutting assembly wherein the canister assembly includes one or more channels or beds.

Another and/or alternative non-limiting object of the present invention is the provision of a method and process for a cutting assembly wherein the canister assembly can be a) directly mounted to the extruder die plate, b) positioned in stream of the extruded strands, or c) used remotely on a bench for batch processing of extruded material.

Another and/or alternative non-limiting object of the present invention is the provision of a method and process for a cutting assembly wherein the canister assembly includes a channel arrangement that is formed of one or more beds or channels that are used to lay, transport, or guide the extruded strands.

Another and/or alternative non-limiting object of the present invention is the provision of a method and process for a cutting assembly wherein the wire bank assembly can be attached to the canister assembly by means of a hinge or linkage which allows reciprocating action of the one or more wires into and out of the cutting slots.

Another and/or alternative non-limiting object of the present invention is the provision of a method and process for a cutting assembly wherein the wire bank assembly can be operated by hand, pneumatic, hydraulic, and/or electric power.

Another and/or alternative non-limiting object of the present invention is the provision of a method and process for a cutting assembly that is configured to cut such extrudate into desired lengths when the un-cut extrudate strand partially or fully fills the canister section.

Another and/or alternative non-limiting object of the present invention is the provision of a method and process for a cutting assembly that can include one or more operational modes (e.g., a manual mode, an automatic mode).

Another and/or alternative non-limiting object of the present invention is the provision of a method and process for a cutting assembly that can include various features used to deactivate the cutting assembly.

Another and/or alternative non-limiting object of the present invention is the provision of a method and process for a cutting assembly that can be ergonomically designed so as to facilitate in the operation of the cutting assembly and/or to facilitate in the repair and maintenance of the cutting assembly.

Another and/or alternative non-limiting object of the present invention is the provision of a method for cutting extrudate that has been extruded from an extruder system comprising: a) providing an extruder system that is configured to extrude material; b)providing a cutting assembly that is configured to cut extrudate material that has been extruded from said extruder system, said cutting assembly comprising a movable cutting bank assembly and a canister assembly, said canister assembly configured to receive extrudate material that has been extruded from said extruder system, said movable cutting assembly movable relative to said canister assembly, said canister assembly includes a channel arrangement, said channel arrangement configured to guide the extrudate material in said canister assembly after the extrudate material is extruded from the extruder assembly, said canister including a first cutting slot that is located across a portion of said channel arrangement, said movable cutting bank assembly including a first cutter that is configured to move at least partially into said first cutting slot to cut the extrudate material located in said channel arrangement when said first cutter is moved between an extended and retracted cutting position; and, c) causing said movable cutting bank assembly to move between said extended and retracted cutting positions to cut said extrudate material.

These and other advantages of the present invention will become more apparent to those skilled in the art from a review of the description of the preferred embodiment and claims.

### BRIEF DESCRIPTION OF THE FIGURES

Reference may now be made to the drawings, which illustrate various embodiments that the invention may take in physical form and in certain parts and arrangements of parts wherein:

FIG. 1 is a partial side elevation view of the cutting assembly in accordance with one embodiment of the invention wherein the cutting assembly is connected to an extruder system and wherein the cutting assembly is positioned in the retracted cutting position;

FIG. 2 is a partial side elevation view of the cutting assembly of FIG. 1 wherein the cutting assembly is positioned in the extended cutting position;

FIG. 3 is a front elevation view of the cutting assembly of FIG. 1 wherein the cutting assembly is positioned in the extended cutting position;

FIG. 4 is a front elevation view of the cutting assembly of FIG. 1 connected to an extruder system and a control box that controls the operation of the cutting assembly;

FIG. 5 a side elevation view of the cutting assembly in accordance with another embodiment of the invention wherein the cutting assembly is connected to an extruder system and wherein the cutting assembly is positioned in the retracted cutting position;

FIG. 6 is a partial side elevation view of the cutting assembly of FIG. 5 wherein the cutting assembly is positioned in the extended cutting position;

FIG. 7 is a front elevation view of the cutting assembly of FIG. 5 wherein two of the cutting assemblies are connected to the extruder system;

FIG. 8 is a front elevation view of the cutting assembly of FIG. 5 wherein eight of the cutting assemblies are connected to the extruder system;

FIG. 9 is a front elevation view of the cutting assembly of FIG. 5 wherein four cutting assemblies are connected to an extruder system and a control box that controls the operation of the cutting assemblies; and

FIG. 10 is a front elevation view of the cutting assembly in accordance with another embodiment of the invention wherein the cutting assembly is connected to an extruder system and wherein the cutting assembly is positioned in the retracted cutting position.

### DETAILED DESCRIPTION OF THE INVENTION

A more complete understanding of the articles/devices, processes, and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

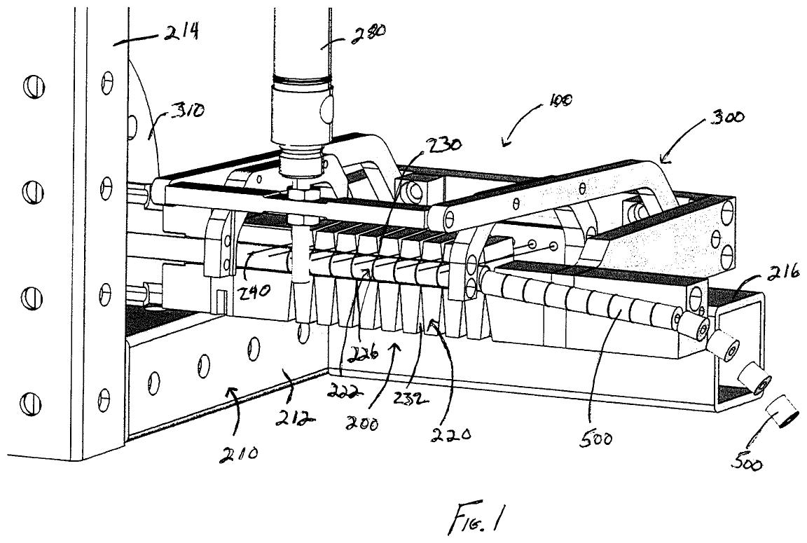

Referring now to the drawings wherein the showing is for the purpose of illustrating preferred embodiments of the invention only and not for the purpose of limiting the same, FIGS. 1-4 illustrate one non-limiting embodiment of the cutting assembly 100 in accordance with the present invention.

The cutting assembly 100 includes a canister assembly 200 and a movable cutting bank assembly 300. The movable cutting bank is configured to be movable relative to the canister assembly between an extended and retracted cutting position.

The canister assembly includes a canister frame 210. The canister frame can optionally include a channel support 212, an upper support 214 and/or a cutting bank support 216. The channel support is configured to support at least a portion of the channel arrangement 220 of the canister assembly 200. The back end of the canister assembly is connected to an extruder system 300. The canister assembly is generally connected to an extruder plate 310 of the extruder system; however, it can be appreciated that the canister assembly can be connected to other or additional portions of the extruder. The type of connection arrangement used to connect the canister assembly to the extruder system is non-limiting (e.g., bolts, clamps, screws, adhesive, hook and loop fastener, weld, solder, tape, etc.).

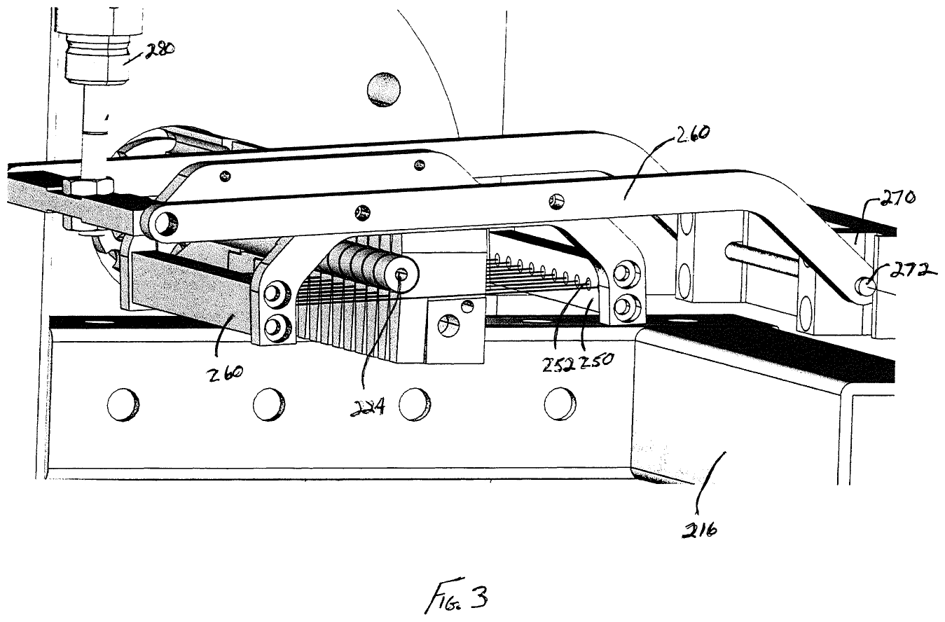

The channel arrangement 220 includes one or more channels 222. Each channel is configured to receive extrudate material 500 that has been extruded from the extruder system 300. Each of the channels are configured to support the extrudate material 500 as it moves through the canister assembly. One or more portions of the channels can partially or fully encircle the extrudate material 500. As illustrated in FIG. 3, the channel 222 includes a channel cavity 224 that fully encircles the extrudate material 500. The channel cavity 224 extends from the front to the back of channel 222. The cross-sectional shape of the channel cavity 224 is illustrated as being generally circular; however, it can be appreciated that the cross-sectional shape of the channel cavity can have other shapes (e.g., oval, star, triangular, square, rectangular, polygonal, etc.). Generally, the cross-sectional shape of the channel cavity is the same as the cross-sectional shape of the extrudate material 500 that exits the extruder system. The size and cross-sectional shape of the channel cavity is selected to enable the extrudate material 500 that exits the extruder system to move into and pass through the channel cavity without damaging or reshaping the cross-sectional shape of the extrudate material 500. Generally, the cross-sectional size of the channel cavity is the same or greater than the cross-sectional size of the extrudate material 500.

Each channel 222 includes one or more cutting slots 226. As illustrated in FIG. 1, channel 222 includes multiple cutting slots that are spaced equal distances from one another so that equal length sections of extrudate material 500 are formed when the extrudate material 500 is cut by the cutting assembly. Each of the cutting slots 226 are configured to pass fully through the cross section of the channel cavity 224. The size and shape of the cutting slots 226 is non-limiting. When multiple cutting slots 226 are included on channel 222, the size, shape, width and configuration of the cutting slots 226 are the same; however, this is not required.

Cutting wire guides 230, 232 can optionally be located above and/or below one or more of the cutting slots 226. The cutting wire guides (when used) are configured to facilitate in guiding the cutting wire 240 into the cutting slots 226 as the movable cutting bank moves between the extended and retracted cutting positions.

As illustrated in FIG. 1, the length of cutting wire guide 230 is shorter than the length of cutting wire guide 230; however, this is not required. The side profile of the cutting wire guides 230, 232 is generally V-shaped with the narrower portion of the cutting wire guides 230, 232 located at the channel 222.

As illustrated in FIGS. 1-3, the movable cutting bank includes one or more cutting wires 240. Generally, the cutting wire is tensioned by at least 100 psi of force; however, this is not required. The arrangement used to tension the cutting wire is non-limiting (e.g., screw, etc.). The cutting wire is sufficiently tensioned so that the cutting wire is generally straight and the size and tension of the wire is selected so that it deflects by less than 5% when cutting the extrudate material. Generally, the diameter of the cutting wire is no more than 0.05 in., and typically no more than 0.02 in.

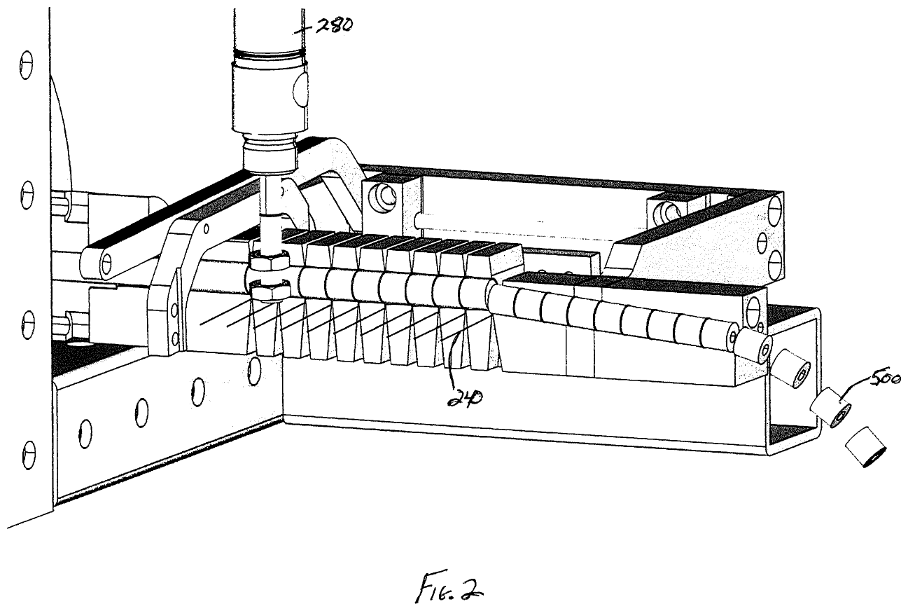

As illustrated in FIG. 3, the movable cutting bank includes first and second wire mount bars 250, 260 to secure each end of the cutting wire. FIGS. 1 and 2 illustrate the movable cutting bank including a first wire mount bar 250 and second wire mount bar 260 (not shown in order to provide a better side view of channel 222). The first and second wire mount bars 250, 260 include openings 252 or some other mount arrangement that releasably connect the cutting wires to the first and second wire mount bars 250, 260. The mount arrangements on the first and second wire mount bars 250, 260 are generally positioned diametrically apart for one another and are positioned on the first and second wire mount bars 250, 260 such that the cutting wires can pass through the cutting slots 226.

The first and second wire mount bars 250, 260 are connected to a cutting bank frame 260. The cutting bank frame is pivotally connected to the frame mount 270 by a pin arrangement 272 or some other arrangement that enables the cutting bank frame to pivot relative to the frame mount 270. The frame mount can be connected to the cutting bank support 216; however, this is not required.

A movement arrangement 280 is connected to the cutting bank frame 260 so as to cause the cutting bank frame 260 to move between an extended and retracted cutting positions. One non-limiting movement arrangement is a pneumatic cylinder having a moveable piston; however, other types of cylinders (hydraulic cylinders), linear drive arrangements, or other movement arrangements can be used to move the cutting bank frame 260 between an extended and retracted cutting positions.

As illustrated in FIGS. 1 and 2, the extrudate material 500 that is located in channel is cut by the cutting wires 240 when the cutting bank frame 260 moves between an extended and retracted cutting positions.

The cutting assembly 100 is mounted to the extruder system 300 so that the extrudate material that is extruded from the extruder system can be continuously cut by the cutting assembly. A control system 400 can optionally be used to control the speed and/or frequency at which the cutting bank frame 260 moves between extended and retracted cutting positions. In one-limiting arrangement, the cutting bank frame 260 does not move between extended and retracted cutting positions until the extrudate material has moved in the channel 222 such that the extrudate material overlies at least one of the cutting slots 226 in the channel 222, and typically all of the cutting slots 226 in the channel. Once the one or more cutting wires have cut the extrudate material, the cutting bank frame 260 generally does not move again between extended and retracted cutting positions until at least one and typically all of the cut extrudate has moved beyond the last active cutting slot (i.e., a cutting slot that is receiving a cutting wire when the cutting bank frame moves between extended and retracted cutting positions) or when at least one and typically all of the cut extrudate has exited the channel. However, it can be appreciated that the cutting bank frame can be moved between an extended and retracted cutting positions at any desired frequency so as to obtain the desired cut length of the extruded material.

In one non-limiting arrangement, the control system 400 can optionally include a control box 402 that includes a manually adjustable timer 410 that can be used to manually control speed and/or frequency at which the cutting bank frame 260 moves between extended and retracted cutting positions.

In another non-limiting arrangement, the control system 400 can include an electronic control system that utilizes one or more sensors, which one or more sensors are used to calculate or otherwise determine the speed at which the extrudate exits the extruder system 300 and/or moves along channel 222. This information can then be used to control speed and/or frequency at which the cutting bank frame 260 moves between extended and retracted cutting positions.

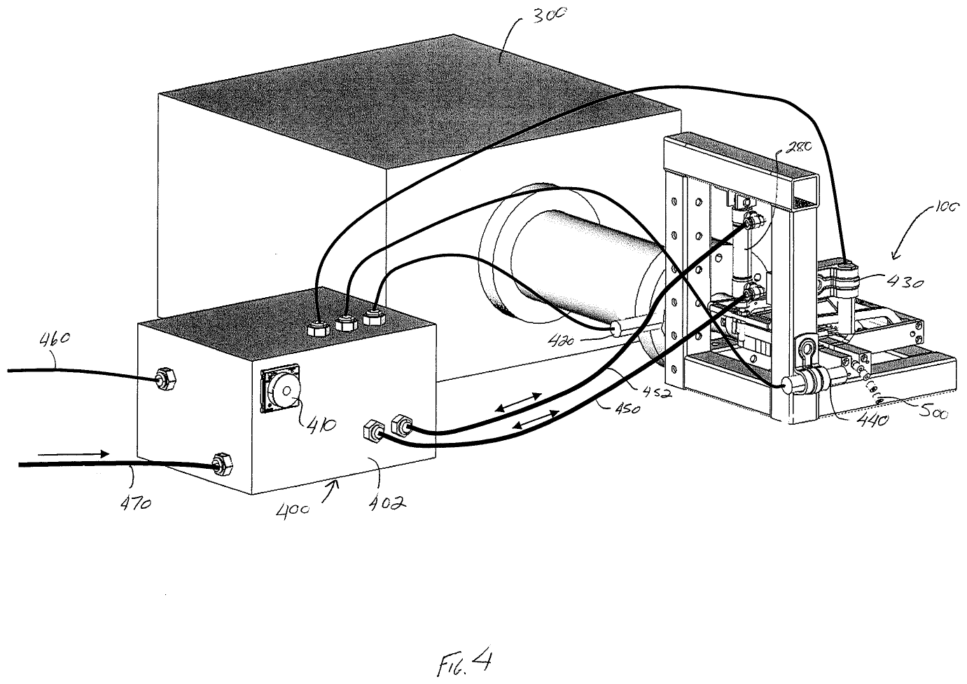

As illustrated in FIG. 4, the control system is connected to one or more sensors. For example, the control system can be connected to a pressure sensor 420, a velocity sensor 430, and/or a counting sensor 440. Information from the one or more sensors 420, 430, 440 is transmitted to the control box 402 and then used to control speed and/or frequency at which the cutting bank frame 260 moves between extended and retracted cutting positions.

As illustrated in FIG. 4, fluid (e.g., air, hydraulic fluid, etc.) supply tubes 450, 452 are optionally connected between the control box 402 and the movement arrangement 280 so as to control the operation of the movement arrangement 280 such a pneumatic cylinder or hydraulic so as to control speed and/or frequency at which the cutting bank frame 260 moves between extended and retracted cutting positions. As can be appreciated, when the movement arrangement 280 is an electric device, the supply tubes can be substituted for a control wire and/or power source.

An electric supply 460 and/or a fluid supply 470 can optionally supply electric power and/or fluid (e.g., pressurized air, hydraulic fluid, etc.) to the control box.

In operation, there is a provided an extruder system that typically includes an auger (not shown) that is designed to move extrudate material (not shown) to be extruded toward an extruder plate 310. The extruder plate has one or more openings (not shown). Although not shown, the opposite end of the auger is typically connected to a motor that is configured to rotate the auger. The use of such a motor and the configuration of the motor and the necessary connection between the motor and auger are well known in the art, thus will not be further described. Also not shown is the feed section for the auger that feeds material to the auger which in turn transports the material to the extruder plate. Many different auger feed arrangements can be used, and many of these feed arrangements are well known in the art and will not be further described.

A wiper blade (not shown) can be optionally connected to auger. The wiper blade is configured to facilitate in directing or encouraging the extrudate material to be extruded through the extruder plate.

A cutting assembly is connected to or positioned closely adjacent to the extruder system to cut extrudate material that has been extruded from the extruder system. The cut extrudate material can have a number of different cross-sectional shapes dependent upon the die plate and/or die inserts used on the extruder system. The length of the cut extruded material product is controlled by the cutting assembly as described above.

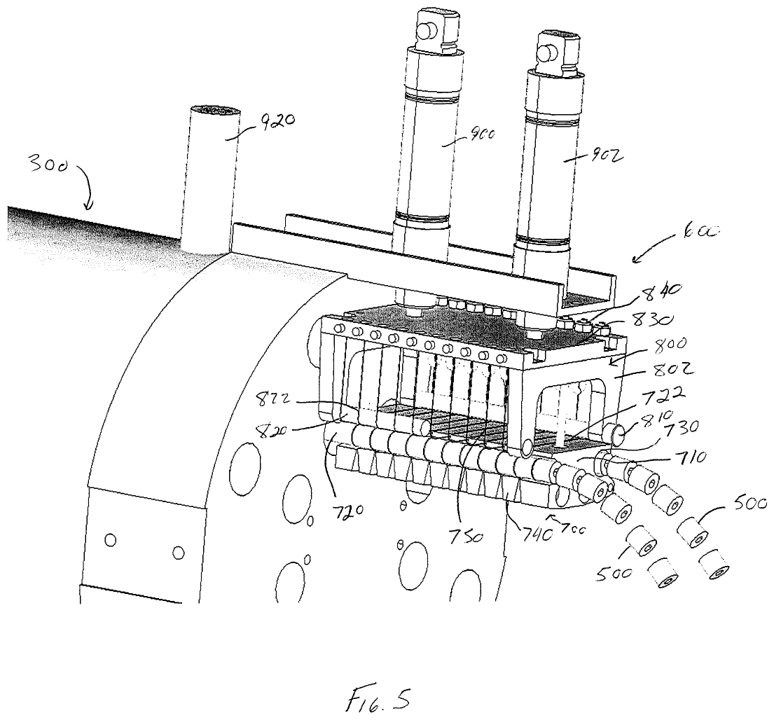

FIGS. 5-9 illustrate another configuration of the cutting assembly. The cutting assembly 600 is illustrated as being connected to the extruder system 300; however, this not required. The cutting assembly 600 includes a canister assembly 700 and a movable cutting bank assembly 800. The movable cutting bank is configured to be movable relative to the canister assembly between an extended and retracted cutting position.

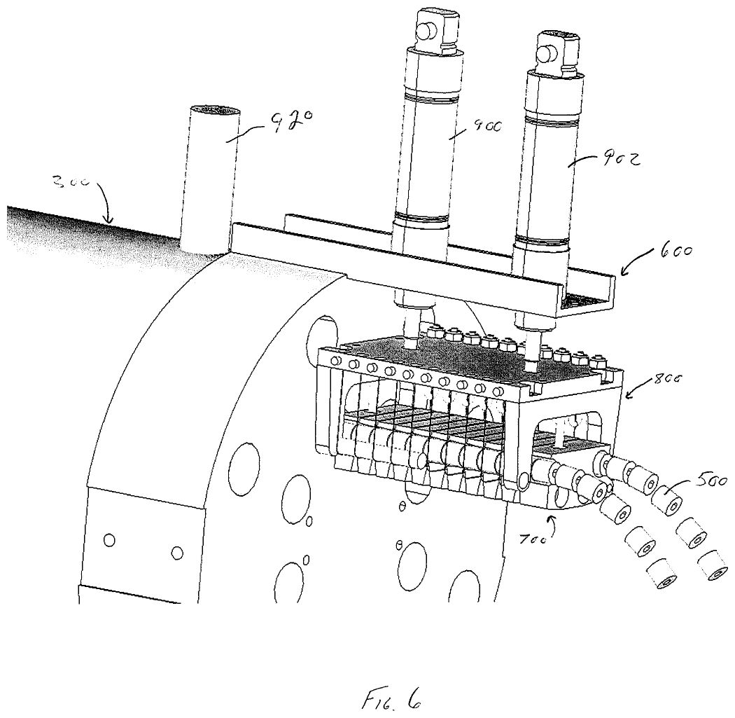

The canister assembly includes channel arrangements 710 that includes two channels 720, 730 having a channel cavity. Each channel is configured to receive extrudate material 500 that has been extruded from the extruder system 300. Each of the channels is configured to support the extrudate material 500 as it moves through the canister assembly. One or more portions of each of the channels can partially or fully encircle the extrudate material 500. The channel 720 illustrated in FIGS. 5 and 6 is partially cut away for purposes of illustrating the extrudate material that is located in the channel. Each of channel 720, 730 fully encircles the extrudate material 500 along different regions of the channel. The channel cavity of each of channels 720, 730 extends from the front to the back of the channel. The cross-sectional shape of the channel cavity of channels 720, 730 is illustrated as being the same and generally circular; however, it can be appreciated that the cross-sectional shape of the channel cavity can have other shapes (e.g., oval, star, triangular, square, rectangular, polygonal, etc.) and the channel cavities can have a different cross-sectional shape. Generally, the cross-sectional shape of the channel cavity is the same as the cross-sectional shape of the extrudate material 500 that exits the extruder system. The size and cross-sectional shape of each of the channel cavities is selected to enable the extrudate material 500 that exits the extruder system to move into and pass through the channel cavity without damaging or reshaping the cross-sectional shape of the extrudate material 500. Generally, the cross-sectional size of each of the channel cavities is the same or greater than the cross-sectional size of the extrudate material 500.

Each channel 720, 730 includes one or more cutting slots 722. As illustrated in FIGS. 5 and 6, channels 720, 730 include multiple cutting slots that are spaced equal distances from one another so that equal length sections of extrudate material 500 are formed when the extrudate material 500 is cut by the cutting assembly. Each of the cutting slots 722 are configured to pass fully through the cross section of the channel cavity of channels 720, 730. The size and shape of the cutting slots 722 is non-limiting. When multiple cutting slots 722 are used, the size, shape, width and configuration of the cutting slots 722 are the same; however, this is not required.

Cutting wire guides 740 can optionally be located above and/or below one or more of the cutting slots 722. The cutting wire guides (when used) are configured to facilitate in guiding the cutting wire 750 into the cutting slots 722 as the movable cutting bank moves between the extended and retracted cutting positions.

The side profile of the cutting wire guides 740 (when used) is generally V-shaped with the narrower portion of the cutting wire guides 740 located at the channels 720, 730.

As illustrated in FIGS. 5 and 6, the movable cutting bank 800 that includes a cutting bank frame 802 includes a plurality of cutting wires 750. Generally, the cutting wire is tensioned by at least 100 psi of force; however, this is not required. The arrangement used to tension the cutting wire is non-limiting (e.g., screw, etc.). The cutting wire is sufficiently tensioned so that the cutting wire is generally straight and the size and tension of the wire is selected so that it deflects by less than 5% when cutting the extrudate material. Generally, the diameter of the cutting wire is no more than 0.05 in., and typically no more than 0.02 in.

As illustrated in FIGS. 5 and 6, the movable cutting bank includes first and second wire mount bars 810, 820 about which the cutting wire is partially positioned and a top frame 830 to which each end of the cutting wire is connected. Tightening nuts 840 are used to adjust the tension of the cutting wires. The mount bars generally includes wire grooves 822 or some other positioning arrangement to maintain the cutting wires in a particular position on the mount bars; however, this is not required. The wire grooves 822 or some other positioning arrangement (when used) are generally positioned diametrically apart for one another such that the cutting wires can pass through the cutting slots 722.

The first and second wire mount bars 810, 820 are connected to the cutting bank frame 802. The cutting bank frame is configured to move in a plane that is generally perpendicular to the longitudinal axis of the channels 720, 730.

A movement arrangement 900, 902 is connected to the cutting bank frame so as to cause the cutting bank frame to move between extended and retracted cutting positions. One non-limiting movement arrangement is a pneumatic cylinder haying a moveable piston; however, other types of cylinders (hydraulic cylinders), linear drive arrangements, or other movement arrangements can be used to move the cutting bank frame between extended and retracted cutting positions.

As illustrated in FIGS. 5 and 6, the extrudate material 500 that is located in channels 720, 730 is cut by the cutting wires 750 when the cutting bank frame 802 moves between extended and retracted cutting positions.

The cutting assembly 600 is mounted to the extruder system 300 so that the extrudate material that is extruded from the extruder system can be continuously cut by the cutting assembly. A control system can optionally be used to control the speed and/or frequency at which the cutting bank frame 802 moves between extended and retracted cutting positions. In one-limiting arrangement, the cutting bank frame 802 does not move between extended and retracted cutting positions until the extrudate material has moved in the channels 720, 730 such that the extrudate material overlies at least one of the cutting slots 722 in the channels 720, 730, and typically all of the cutting slots 722 in the channel. Once the one or more cutting wires have cut the extrudate material, the cutting bank frame 802 generally does not move again between extended and retracted cutting positions until at least one and typically all of the cut extrudate has moved beyond the last active cutting slot (i.e., a cutting slot that is receiving a cutting wire when the cutting bank frame moves between extended and retracted cutting positions) or when at least one and typically all of the cut extrudate has exited the channel. However, it can be appreciated that the cutting bank frame can be moved between extended and retracted cutting positions at any desired frequency so as to obtain the desired cut length of the extrude material.

In one non-limiting arrangement, the control system can optionally include a control box that includes a manually adjustable timer that can be used to manually control speed and/or frequency at which the cutting bank frame moves between extended and retracted cutting positions.

In another non-limiting arrangement, the control system can include an electronic control system that utilizes one or more sensors, which one or more sensors are used to calculate or otherwise determine the speed at which the extrudate exits the extruder system 300 and/or moves along channels 720, 730. This information can then be used to control speed and/or frequency at which the cutting bank frame 800 moves between extended and retracted cutting positions.

The control system is generally connected to one or more sensors. For example, the control system can be connected to a pressure sensor 920, a velocity sensor, and/or a counting sensor. Information from the one or more sensors is transmitted to the control box and then is used to control speed and/or frequency at which the cutting bank frame 802 moves between extended and retracted cutting positions.

Fluid (e.g., air, hydraulic fluid, etc.) supply tubes can be optionally connected between the control box and the movement arrangement 900, 902 so as to control the operation of the movement arrangement 900, 902 (e.g., pneumatic cylinder or hydraulic cylinder) so as to control speed and/or frequency at which the cutting bank frame 802 moves between extended and retracted cutting positions. As can be appreciated, when the movement arrangement is electric device, the supply tubes can be substituted for a control wire and/or power source.

An electric supply and/or a fluid supply can optionally supply electric power and/or fluid (e.g., pressurized air, hydraulic fluid, etc.) to the control box.

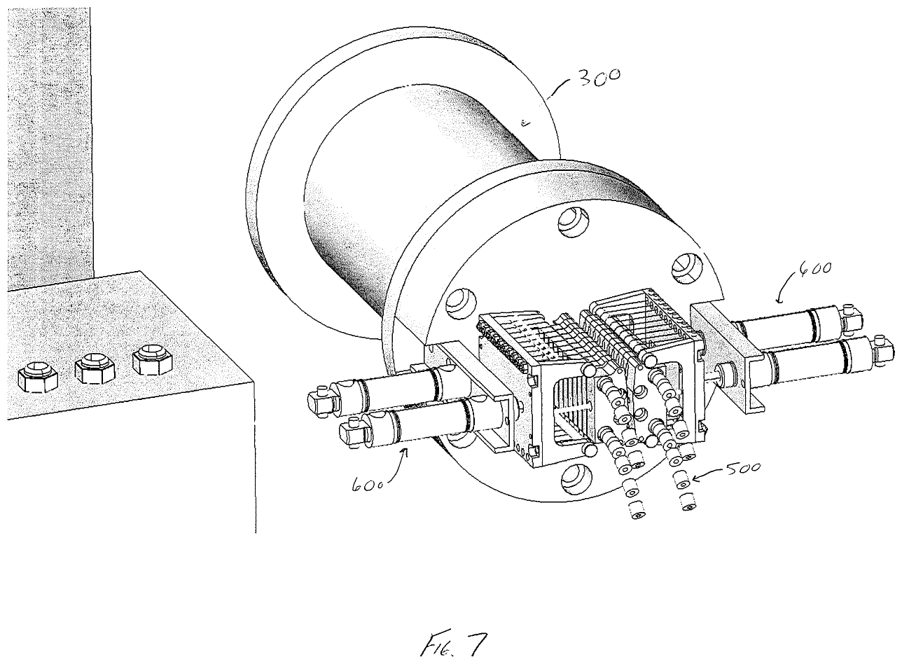

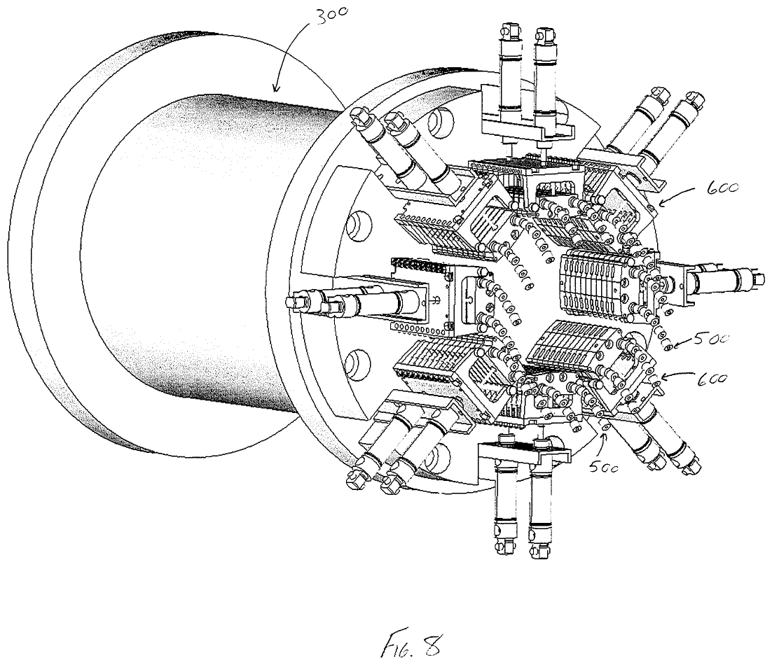

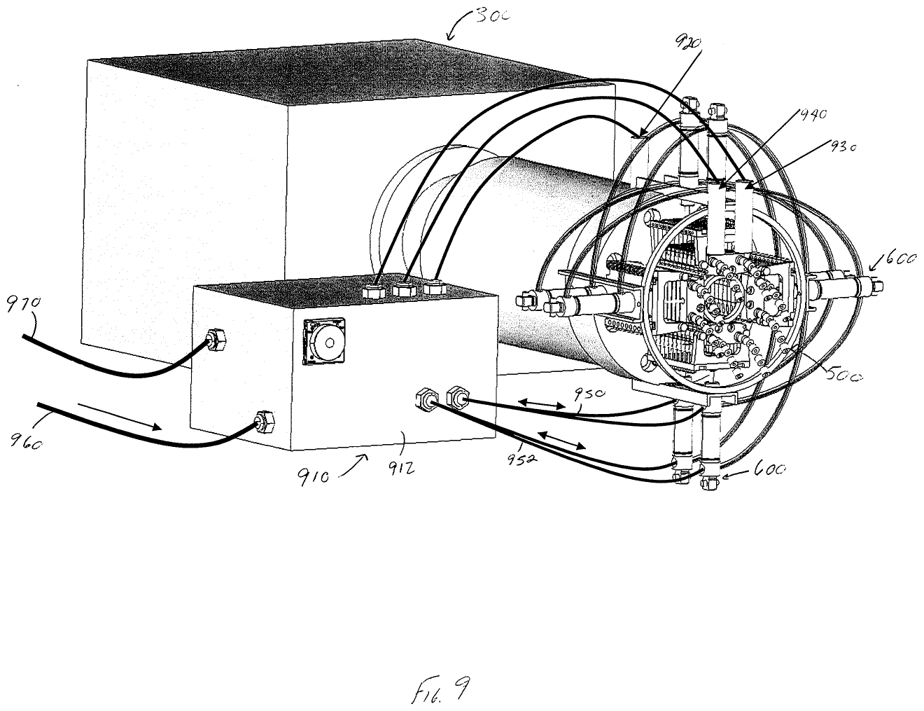

FIG. 7 illustrates two cutting assemblies 600 connected to the extruder system. The operation and features of the two cutting assemblies 600 are the same as described above with regard to the cutting assembly illustrated in FIGS. 5 and 6. As illustrated in FIG. 7, the two cutting assemblies 600 are illustrated as being connected across from one another when connected to the extruder system; however, it can be appreciated that any configuration and any number of cutting assemblies can be connected to the extruder system. For example, FIG. 8 illustrates eight cutting assemblies 600 connected to the extruder system 300 and FIG. 9 illustrates four cutting assemblies 600 connected to the extruder system 300.

FIG. 9 also illustrates a control system 910 that can be used to control one or more of the cutting assemblies illustrated in FIGS. 5-10. The control system 910 can be the same or similar to the control system 400 described above in FIG. 4.

As illustrated in FIG. 9, the control system is connected to one or more sensors. For example, the control system can be connected to a pressure sensor 920, a velocity sensor 930, and/or a counting sensor 940. Information from the one or more sensors is transmitted to the control box 912 and then used to control speed and/or frequency at which the cutting bank frame 802 moves between extended and retracted cutting positions.

As illustrated in FIG. 9, fluid (e.g., air, hydraulic fluid, etc.) supply tubes 950, 952 are optionally connected between the control box 912 and the movement arrangement 900, 902 for each of the cutting assemblies so as to control the operation of the movement arrangement (e.g., a pneumatic cylinder or hydraulic cylinder) so as to control speed and/or frequency at which the cutting bank frame 802 on each of the cutting assemblies moves between extended and retracted cutting positions. As can be appreciated, when the movement arrangement is an electric device, the supply tubes can be substituted for a control wire and/or power source.

An electric supply 960 and/or a fluid supply 970 can optionally supply electric power and/or fluid (e.g., pressurized air, hydraulic fluid, etc.) to the control box.

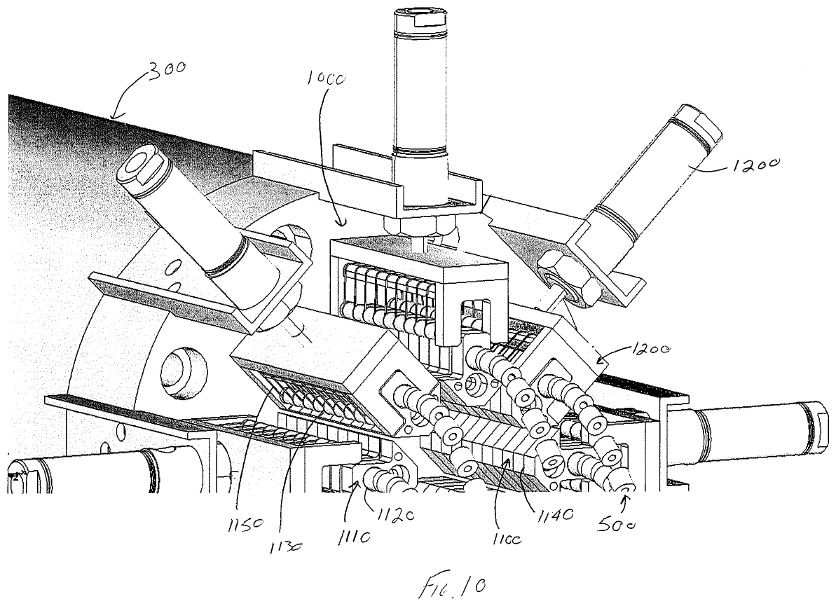

Referring now to FIG. 10, there is illustrated a cutting assembly 1000 that is a modification of the cutting assembly illustrated in FIGS. 5-9 in that cutting assembly 1000 only includes a single channel in the canister assembly. Also, only one movement arrangement is connected to the cutting bank frame so as to cause the cutting bank frame to move between extended and retracted cutting positions. FIG. 10 also illustrates that one or more of the cutting assemblies are in the extended cutting positions while one or more of the cutting assemblies are in the retracted cutting positions. As can be appreciated with respect to the cutting assemblies illustrated in FIGS. 6-10, the cutting position of all of the cutting assemblies can be the same or the cutting position of one or more of the cutting assemblies can be different from one or more other cutting assemblies.

The cutting assembly 1000 is illustrated as being connected to the extruder system 300; however, this not required. The cutting assembly 1000 includes a canister assembly 1100 and a movable cutting bank assembly 1200. The movable cutting bank is configured to be movable relative to the canister assembly between extended and retracted cutting positions.

The canister assembly includes a channel arrangement 1110 that includes a single channel 1120 having a channel cavity. The channel is configured to receive extrudate material 500 that has been extruded from the extruder system 300. The channel is configured to support the extrudate material 500 as it moves through the canister assembly. One or more portions of the channel can partially or fully encircle the extrudate material 500. The channel cavity of the channel extends from the front to the back of the channel. The cross-sectional shape of the channel cavity is illustrated as being the same and generally circular; however, it can be appreciated that the cross-sectional shape of the channel cavity can have other shapes (e.g., oval, star, triangular, square, rectangular, polygonal, etc.) and the channel cavity can have a different cross-sectional shape. Generally, the cross-sectional shape of the channel cavity is the same as the cross-sectional shape of the extrudate material 500 that exits the extruder system. The size and cross-sectional shape of the channel cavity is selected to enable the extrudate material 500 that exits the extruder system to move into and pass through the channel cavity without damaging or reshaping the cross-sectional shape of the extrudate material 500. Generally, the cross-sectional size of the channel cavity is the same or greater than the cross-sectional size of the extrudate material 500.

The channel 1120 includes one or more cutting slots 1130. As illustrated in FIG. 10, the channels includes multiple cutting slots that are spaced equal distances from one another so that equal length sections of extrudate material 500 are formed when the extrudate material 500 is cut by the cutting assembly. Each of the cutting slots is configured to pass fully through the cross-section of the channel cavity of channel 1120. The size and shape of the cutting slots is non-limiting. When multiple cutting slots are used, the size, shape, width and configuration of the cutting slots are the same; however, this is not required.

Cutting wire guides 1140 can optionally be located above and/or below one or more of the cutting slots. The cutting wire guides (when used) are configured to facilitate in guiding the cutting wire 1150 into the cutting slots as the movable cutting bank moves between the extended and retracted cutting positions.

The side profile of the cutting wire guides (when used) is generally V-shaped with the narrower portion of the cutting wire guides located at the channel.

As illustrated in FIG. 10, the movable cutting bank that includes a cutting bank frame includes a plurality of cutting wires. Generally, the cutting wire is tensioned by at least 100 psi of force; however, this is not required. The arrangement used to tension the cutting wire is non-limiting (e.g., screw, etc.). The cutting wire is sufficiently tensioned so that the cutting wire is generally straight and the size and tension of the wire is selected so that it deflects by less than 5% when cutting the extrudate material. Generally, the diameter of the cutting wire is no more than 0.05 in., and typically no more than 0.02 in.

As illustrated in FIGS. 5 and 6, the movable cutting bank includes first and second wire mount bars about which the cutting wire is partially positioned and a top frame to which each end of the cutting wire is connected. Tightening nuts (not shown) can be used to adjust the tension of the cutting wires; however, other arrangement can be used. The mount bars generally includes wire grooves or some other positioning arrangement to maintain the cutting wires in a particular position on the mount bars; however, this is not required. The wire grooves or some other positioning arrangement (when used) are generally positioned diametrically apart for one another such that the cutting wires can pass through the cutting slots.

The first and second wire mount bars are connected to the cutting bank frame. The cutting bank frame is configured to move in a plane that is generally perpendicular to the longitudinal axis of the channel.

A movement arrangement 1200 is connected to the cutting bank frame so as to cause the cutting bank frame to move between extended and retracted cutting positions. One non-limiting movement arrangement is a pneumatic cylinder having a moveable piston; however, other types of cylinders (hydraulic cylinders), linear drive arrangements, or other movement arrangements can be used to move the cutting bank frame between extended and retracted cutting positions.

The extrudate material 500 located in the channel is cut by the cutting wires when the cutting bank frame moves between extended and retracted cutting positions.

The cutting assembly 1000 is mounted to the extruder system 300 so that the extrudate material that is extruded from the extruder system can be continuously cut by the cutting assembly. A control system can optionally be used to control the speed and/or frequency at which the cutting bank frame moves between extended and retracted cutting positions. In one-limiting arrangement, the cutting bank frame does not move between extended and retracted cutting positions until the extrudate material has moved in the channel such that the extrudate material overlies at least one of the cutting slots 722 in the channel, and typically all of the cutting slots in the channel. Once the one or more cutting wires have cut the extrudate material, the cutting bank frame generally does not move again between extended and retracted cutting positions until at least one and typically all of the cut extrudate has moved beyond the last active cutting slot (i.e., a cutting slot that is receiving a cutting wire when the cutting bank frame moves between an extended and retracted cutting positions) or when at least one and typically all of the cut extrudate has exited the channel. However, it can be appreciated that the cutting bank frame can be moved between extended and retracted cutting positions at any desired frequency so as to obtain the desired cut length of the extrudate material.

In one non-limiting arrangement, the control system can optionally include a control box that includes a manually adjustable timer that can be used to manually control speed and/or frequency at which the cutting bank frame moves between extended and retracted cutting positions.

In another non-limiting arrangement, the control system can include an electronic control system that utilizes one or more sensors, which one or more sensors calculate or otherwise determine the speed at which the extrudate exits the extruder system 300 and/or moves along the channel. This information can then be used to control speed and/or frequency at which the cutting bank frame moves between extended and retracted cutting positions.

The control system is generally connected to one or more sensors. For example, the control system can be connected to a pressure sensor, a velocity sensor, and/or a counting sensor. Information from the one or more sensors is transmitted to the control box and then is used to control speed and/or frequency at which the cutting bank frame moves between extended and retracted cutting positions.

Fluid (e.g., air, hydraulic fluid, etc.) supply tubes can be optionally connected between the control box and the movement arrangement so as to control the operation of the movement arrangement (e.g., pneumatic cylinder or hydraulic cylinder) so as to control speed and/or frequency at which the cutting bank frame moves between extended and retracted cutting positions. As can be appreciated, when the movement arrangement can be an electric device, the supply tubes can be substituted for a control wire and/or power source.

An electric supply and/or a fluid supply can optionally supply electric power and/or fluid (e.g., pressurized air, hydraulic fluid, etc.) to the control box.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

What is claimed:

1. A cutting assembly configured to cut an extrudate material that has been extruded from an extruder system, said cutting assembly comprising a movable cutting bank assembly and a canister assembly, said canister assembly configured to be connectable to said extruder system, said movable cutting assembly movable relative to said canister assembly, said canister assembly includes a channel arrangement that is at least partially aligned with an opening in a plate or a die of said extruder a system, said channel arrangement configured to guide the extrudate material in said canister assembly after the extrudate material is extruded from the extruder assembly, said canister including a first cutting slot that is located across a portion of said channel arrangement, said movable cutting bank assembly including a first cutter that is configured to move at least partially into said first cutting slot to cut the extrudate material located in said channel arrangement when said first cutter is moved between extended and retracted cutting position.

2. The cutting assembly as defined in claim 1, wherein said channel arrangement is configured to fully encircle at least a portion of the extrudate material on each side of said first cutting slot when the extrudate material is located in said channel arrangement.

3. The cutting assembly as defined in claim 1, wherein said first cutter is a tensioned cutting wire.

4. The cutting assembly as defined in claim 1, wherein said extruder system includes an extruder plate that includes an inner face and a front face, a feed arrangement configured to feed said the extrudate material toward said inner face of said extruder plate to cause the extrudate material to pass through said at least one opening in said extruder plate, said feed arrangement including a feed housing, said extruder plate removably connected or interconnected to said feed housing, said cutting assembly including a drive system to cause said movable cutting bank assembly to move relative to said canister assembly so that said first cutter can move between extended and retracted cutting position, said cutting assembly including a cutter control system configured to at least partially control a rate of cutting of the extrudate material by said movable cutting bank assembly, said cutter control system including a controller configured to process at least one type of detected information from at least one type of detector and to use such detected information to at least partially control a rate of cutting of the extrudate material by said movable cutting bank assembly, said detected information including one or more types of information selected from the group consisting of a) pressure of the extrudate material prior to entering said at least one die plate opening, b) pressure of the extrudate material in said at least one die plate opening, c) temperature of the extrudate material prior to entering said at least one die plate opening, d) temperature of the extrudate material in said at least one die plate opening, e) velocity of the extrudate material prior to entering said at least one die plate opening, f) velocity of the extrudate material in said at least one die plate opening, g) velocity of the extrudate material exiting said at least one die plate opening, h) change of velocity of the extrudate material prior to entering said at least one die plate opening, i) change of velocity of the extrudate material in said at least one die plate opening, j) change of velocity of the extrudate material exiting said at least one die plate opening, k) velocity of the extrudate material moving on said channel arrangement of said canister assembly, l) change of velocity of the extrudate material moving on said channel arrangement of said canister assembly, m) velocity of the extrudate material entering said channel arrangement of said canister assembly, n) change of velocity of the extrudate material entering said channel arrangement of said canister assembly, o) velocity of the extrudate material exiting said channel arrangement of said canister assembly, p) change of velocity of the extrudate material exiting said channel arrangement of said canister assembly, q) total weight over a certain time period of the extrudate material that has exited said canister assembly, r) length of the cut extrudate material, s) time period required for the extrudate material to move through said at least one die plate opening, t) time period for the extrudate material to move to said extruder plate, and u) rate of cutting by said movable cutting bank assembly.

5. The cutting assembly as defined in claim 1, including a data storage arrangement to store information regarding one or more types of information selected from the group consisting of a) pressure of the extrudate material prior to entering said at least one die plate opening, b) pressure of the extrudate material in said at least one die plate opening, c) temperature of the extrudate material prior to entering said at least one die plate opening, d) temperature of the extrudate material in said at least one die plate opening, e) velocity of the extrudate material prior to entering said at least one die plate opening, f) velocity of the extrudate material in said at least one die plate opening, g) velocity of the extrudate material exiting said at least one die plate opening, h) change of velocity of the extrudate material prior to entering said at least one die plate opening, i) change of velocity of the extrudate material in said at least one die plate opening, j) change of velocity of the extrudate material exiting said at least one die plate opening, k) velocity of the extrudate material moving on said channel arrangement of said canister assembly, l) change of velocity of the extrudate material moving on said channel arrangement of said canister assembly, m) velocity of the extrudate material entering said channel arrangement of said canister assembly, n) change of velocity of the extrudate material entering said channel arrangement of said canister assembly, o) velocity of the extrudate material exiting said channel arrangement of said canister assembly, p) change of velocity of the extrudate material exiting said channel arrangement of said canister assembly, q) total weight over a certain time period of the extrudate material that has exited said canister assembly, r) length of the cut extrudate material, s) time period required for the extrudate material to move through said at least one die plate opening, t) time period for the extrudate material to move to said extruder plate, and u) rate of cutting by said movable cutting bank assembly.

6. The cutting assembly as defined in claim 1, wherein said extruder system includes a wiper that includes at least one wiper blade, said wiper configured to be connect to an auger or a rotating member, said wiper configured to be disposed adjacent said inner face of said extruder plate, said at least one wiper blade on said wiper being a radially disposed blade, said at least one wiper blade designed to direct the extrudate material into said at least one die plate opening.

7. An extruder arrangement comprising an extruder system and a cutting assembly, said extruder system includes an extruder plate that includes an inner face and a front face, a feed arrangement configured to feed said the extrudate material toward said inner face of said extruder plate to cause the extrudate material to pass through said at least one opening in said extruder plate, said feed arrangement including a feed housing, said extruder plate removably connected or interconnected to said feed housing, said cutting assembly configured to cut an extrudate material that has been extruded from said extruder system, said cutting assembly comprising a movable cutting bank assembly and a canister assembly, said canister assembly configured to be connectable to said extruder system, said movable cutting assembly movable relative to said canister assembly, said canister assembly includes a channel arrangement that is at least partially aligned with an opening in a plate or a die of said extruder a system, said channel arrangement configured to guide the extrudate material in said canister assembly after the extrudate material is extruded from the extruder assembly, said canister including a first cutting slot that is located across a portion of said channel arrangement, said movable cutting bank assembly including a first cutter that is configured to move at least partially into said first cutting slot to cut the extrudate material located in said channel arrangement when said first cutter is moved between extended and retracted cutting position.

8. The extruder arrangement as defined in claim 7, wherein said channel arrangement is configured to fully encircle at least a portion of the extrudate material on each side of said first cutting slot when the extrudate material is located in said channel arrangement.

9. The extruder arrangement as defined in claim 7, wherein said first cutter is a tensioned cutting wire.

10. The extruder arrangement as defined in claim 7, wherein said extruder system includes an extruder plate that includes an inner face and a front face, a feed arrangement configured to feed said the extrudate material toward said inner face of said extruder plate to cause the extrudate material to pass through said at least one opening in said extruder plate, said feed arrangement including a feed housing, said extruder plate removably connected or interconnected to said feed housing, said cutting assembly including a drive system to cause said movable cutting bank assembly to move relative to said canister assembly so that said first cutter can move between an extended and retracted cutting position, said cutting assembly including a cutter control system configured to at least partially control a rate of cutting of the extrudate material by said movable cutting bank assembly, said cutter control system including a controller configured to process at least one type of detected information from at least one type of detector and to use such detected information to at least partially control a rate of cutting of the extrudate material by said movable cutting bank assembly, said detected information including one or more types of information selected from the group consisting of a) pressure of the extrudate material prior to entering said at least one die plate opening, b) pressure of the extrudate material in said at least one die plate opening, c) temperature of the extrudate material prior to entering said at least one die plate opening, d) temperature of the extrudate material in said at least one die plate opening, e) velocity of the extrudate material prior to entering said at least one die plate opening, f) velocity of the extrudate material in said at least one die plate opening, g) velocity of the extrudate material exiting said at least one die plate opening, h) change of velocity of the extrudate material prior to entering said at least one die plate opening, i) change of velocity of the extrudate material in said at least one die plate opening, j) change of velocity of the extrudate material exiting said at least one die plate opening, k) velocity of the extrudate material moving on said channel arrangement of said canister assembly, l) change of velocity of the extrudate material moving on said channel arrangement of said canister assembly, m) velocity of the extrudate material entering said channel arrangement of said canister assembly, n) change of velocity of the extrudate material entering said channel arrangement of said canister assembly, o) velocity of the extrudate material exiting said channel arrangement of said canister assembly, p) change of velocity of the extrudate material exiting said channel arrangement of said canister assembly, q) total weight over a certain time period of the extrudate material that has exited said canister assembly, r) length of the cut extrudate material, s) time period required for the extrudate material to move through said at least one die plate opening, t) time period for the extrudate material to move to said extruder plate, and u) rate of cutting by said movable cutting bank assembly.

11. The extruder arrangement as defined in claim 7, including a data storage arrangement to store information regarding one or more types of information selected from the group consisting of a) pressure of the extrudate material prior to entering said at least one die plate opening, b) pressure of the extrudate material in said at least one die plate opening, c) temperature of the extrudate material prior to entering said at least one die plate opening, d) temperature of the extrudate material in said at least one die plate opening, e) velocity of the extrudate material prior to entering said at least one die plate opening, f) velocity of the extrudate material in said at least one die plate opening, g) velocity of the extrudate material exiting said at least one die plate opening, h) change of velocity of the extrudate material prior to entering said at least one die plate opening, i) change of velocity of the extrudate material in said at least one die plate opening, j) change of velocity of the extrudate material exiting said at least one die plate opening, k) velocity of the extrudate material moving on said channel arrangement of said canister assembly, l) change of velocity of the extrudate material moving on said channel arrangement of said canister assembly, m) velocity of the extrudate material entering said channel arrangement of said canister assembly, n) change of velocity of the extrudate material entering said channel arrangement of said canister assembly, o) velocity of the extrudate material exiting said channel arrangement of said canister assembly, p) change of velocity of the extrudate material exiting said channel arrangement of said canister assembly, q) total weight over a certain time period of the extrudate material that has exited said canister assembly, r) length of the cut extrudate material, s) time period required for the extrudate material to move through said at least one die plate opening, t) time period for the extrudate material to move to said extruder plate, and u) rate of cutting by said movable cutting bank assembly.

12. The extruder arrangement as defined in claim 7, wherein said extruder system includes a wiper that includes at least one wiper blade, said wiper configured to be connect to an auger or a rotating member, said wiper configured to be disposed adjacent said inner face of said extruder plate, said at least one wiper blade on said wiper being a radially disposed blade, said at least one wiper blade designed to direct the extrudate material into said at least one die plate opening.

13. A method for cutting extrudate that has been extruded from an extruder system comprising:
providing an extruder system that is configured to extrude extrudate material;
providing a cutting assembly that is configured to cut extrudate material that has been extruded from said extruder system, said cutting assembly comprising a movable cutting bank assembly and a canister assembly, said canister assembly configured receive extrudate material that has been extruded from said extruder system, said movable cutting assembly movable relative to said canister assembly, said canister assembly includes a channel arrangement, said channel arrangement configured to guide the extrudate material in said canister assembly after the extrudate material is extruded from the extruder assembly, said canister including a first cutting slot that is located across a portion of said channel arrangement, said movable cutting bank assembly including a first cutter that is configured to move at least partially into said first cutting slot to cut the extrudate material located in said channel arrangement when said first cutter is moved between extended and retracted cutting positions; and,
causing said movable cutting bank assembly to move between said extended and retracted cutting position to cut said extrudate material.
